(19) United States
(12) Patent Application Publication
(10) Pub. No.: US 2023/0033395 A1
(43) Pub. Date: Feb. 2, 2023

(54) QUASI-SOLID-STATE LITHIUM TELLURIUM BATTERIES HAVING FLEXIBLE GEL POLYMER ELECTROLYTES

(71) Applicant: The University of British Columbia, Vancouver (CA)

(72) Inventors: Yue Zhang, Kelowna (CA); Dan Oliric Manaig, Kelowna (CA); Don J. Freschi, Kelowna (CA); Jian Liu, Kelowna (CA)

(73) Assignee: The University of British Columbia, Vancouver (CA)

(21) Appl. No.: 17/384,043

(22) Filed: Jul. 23, 2021

(51) Int. Cl. H01M 10/0565; H01M 4/134; H01M 10/0525

(52) U.S. Cl. CPC H01M 10/0565; H01M 4/134; H01M 10/0525; H01M 2004/027

(57) ABSTRACT

Disclosed is a lithium ion battery comprising a lithium anode, a tellurium cathode and a gel polymer electrolyte. The gel polymer electrolyte may comprise a polymer matrix and a lithium compatible salt.

### BACKGROUND

### 1. Technical Field

This disclosure relates generally to lithium-ion batteries and in particular to a battery having a tellurium cathode and a gel polymer electrolyte.

### 2. Description of Related Art

Lithium-ion batteries (LIBs) are considered one of the most reliable technologies for large-scale energy storage due to their high energy and long lifetime. The broad applications of batteries in electric vehicles and emerging smart devices call for further development in lithium batteries to meet the increasing demand for enhanced energy and safety. However, the energy density of LIBs is limited by the low capacity of electrode materials. In particular, the theoretical capacity of the most commonly used cathode materials, such as LiMO2 (M=Ni, Co, Mn) and LiFePO4, is below 180 mAh g⁻¹. To address this limitation, it has been proposed to utilize alternative electrode materials.

In particular, Lithium-sulfur (Li—S) battery has been proposed due to its ultrahigh theoretical capacity of 1675 mAh g⁻¹. However, its practical capacity is far below this value, which is primarily caused by the intrinsic electrical conductivity of S (5×10⁻²⁸ S m⁻¹) and “shuttle effect”. The low conductivity leads to slow electrochemical reaction kinetics, poor practical capacity, and active material utilization. The “shuttle effect”, originating from the dissolution and migration of polysulfides intermediates in ether electrolytes, also results in the decrease of effective active materials and poor electrochemical stability. Furthermore, selenium (Se) has also been proposed as a cathode material candidate because of the improved electrical conductivity (1×10⁻³ S m⁻¹) and high specific capacity (675 mAh g⁻¹). Despite promising reports on Li—S and Li—Se batteries, the redox kinetics is still a bottleneck for the commercialization of these batteries.

### SUMMARY OF THE DISCLOSURE

According to a first embodiment, there is disclosed a lithium ion battery comprising a lithium anode, a tellurium cathode and a gel polymer electrolyte.

The gel polymer electrolyte may comprise a polymer matrix and a lithium compatible salt. The polymer matrix may comprise poly(vinylidene fluoride-co-hexafluoropropylene). The lithium compatible salt may comprise and bis(trifluoromethanesulfonyl)imide lithium. The tellurium cathode may comprise a quantity of tellurium encapsulated in porous carbon.

According to a further embodiment, there is disclosed an electrolyte for use in a lithium ion battery comprising a gel polymer matrix and a lithium compatible salt. The gel polymer matrix may comprises poly(vinylidene fluoride-co-hexafluoropropylene). The lithium compatible salt may comprise bis(trifluoromethanesulfonyl)imide lithium.

Other aspects and features of the present disclosure will become apparent to those ordinarily skilled in the art upon review of the following description of specific embodiments in conjunction with the accompanying figures.

### BRIEF DESCRIPTION OF THE DRAWINGS

The accompanying drawings constitute part of the disclosure. Each drawing illustrates exemplary aspects wherein similar characters of reference denote corresponding parts in each view,

FIG. 1 is a cross sectional view of an exemplary battery according to an embodiment of the present disclosure.

FIG. 2a-2h are illustrations of the Te/C cathode.

FIG. 3 is a graph of ionic conductivities of GPEs. Vs. NMP uptake.

FIGS. 4a-4e are scanning electron images and plots of the Li/GPE/SS cells of an exemplary embodiment of the battery

FIG. 5 is a nyquist plot of the Li/GPE/Li cell of one exemplary embodiment.

FIG. 6a-6b are illustrations of an exemplary battery of the present disclosure.

FIG. 6c-6d are charts of the cycling performance of the Li/GPE/Te batteries using PVDF and SA binders.

FIG. 6e-6j are ESI plots and scanning electron images of cathodes with PVDF and SA binders.

FIG. 7a-7b are rate performance and charge-discharge profiles of the Li/GPE/Te battery using PVDF binder.

FIG. 8 is a chart of the cycling performance of S/D, Se/C and Te/C cathodes.

FIG. 9a-9c are galvanostatic charge-discharge profiles of the S/C, Se/C and Te/C cathodes.

FIG. 10 is a chart of the capacity retention of the S/C, Se/C and Te/C cathodes.

FIG. 11 is nyquist plots of the Li—S/Se/Te batteries before and after cycling.

### DETAILED DESCRIPTION

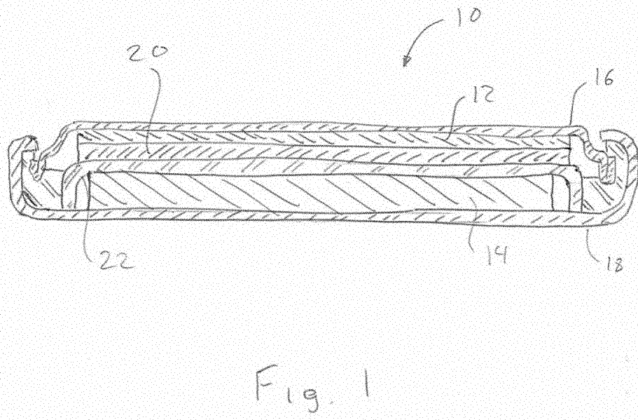

Aspects of the present disclosure are now described with reference to exemplary apparatuses, methods and systems. Referring to FIG. 1, an exemplary battery according to a first embodiment is shown generally at 10. The battery 10 includes an anode 12 and a cathode 14 contained within a housing, which may be formed as top and bottom portions 16 and 18, respectively. The battery 10 further includes an electrolyte 20 and a separator 22 as are conventional. It will be appreciated that the above structure and illustrated layout for the battery 10 is exemplary only and that other designs for the battery may also be utilized. The battery 10 comprises a lithium-ion battery having a lithium anode 12 and a tellurium based cathode 14 and a flexible gel polymer electrolyte. It will also be appreciated that the lithium anode may be of any form and composition.

As utilized herein, in exemplary embodiments, the gel polymer electrolyte 20 is selected to be formed comprises a polymer matrix, a lithium salt, and may optionally include other components as necessary or desirable, such as additional electrolytes or trace amounts of solvents such as N-methyl-2-pyrrolidone (NMP), ethylene carbonate (EC), propylene carbonate (PC), dimethylformamide (DMF), or the like by way of non-limiting example. Additionally, the gel polymer electrolytes may be selected exhibit ionic conductivity approaching to or beyond 10⁻⁴ S/cm at room temperature, transference number of lithium ions approaching unity, good chemical, thermal, and electrochemical stabilities and good mechanical strength for manufacturing. By way of non-limiting example, the gel polymer matrix may comprise poly(vinylidene fluoride-co-hexafluoropropylene) (PVDF-HFP), sodium agminate, poly(vinylidene fluoride-co-hexafluoropropylene) (PVDF-HFP), poly(ethylene oxide) (PEO), poly(acrylonitride) (PAN), poly(methyl methacrylate) (PMMA), and oly(vinylidene fluoride) (PVDF) or the like. In particular PVDF-HFP has been found to be particularly useful due to its excellent electrochemical and thermal stability, mechanical strength, and dielectric constant (8.4). GPE possesses a high ionic conductivity of 8.0×10⁻⁴ S cm⁻¹ at 25° C., broad electrochemical stability up to 4.82 V, and excellent interfacial compatibility with Li metal.

The cathode includes quantity of Te including, without limitation, pure Te, encapsulating Te into porous carbon, ultrahigh tellurium nanowires wrapped by conductive and porous reduced graphene oxide, cobalt-doped porous carbon polyhedra derived from metal organic framework as the Te host. Other method of forming a Tellurium/carbon composite (Te/C) cathode may also be utilized including without limitation mesoporous CMK-3, carbon nanotubes, rib-like hierarchical carbon, and other porous carbon have been employed to accommodate the volume change of Te. It will be appreciated that microporous carbon is utilized as the Te host to buffer volume change and maintain structural stability. Compared with S and Se, the high electrical conductivity of Te enables fast electron transfer and low interfacial resistance, thus contributing to superior cycling stability.

### EXAMPLE

In one exemplary embodiment, a porous carbon is employed as Te host to produce Te/C composite to buffer the volume change of Te during the lithiation/de-lithiation process. The Te/C composite was synthesized via a melt-diffusion method. The tellurium powder and porous carbon (Adven Industries Inc., used as received) were mixed at the mass ratio of 2:1 and fully grounded. Then the mixture was transferred to a closed tube furnace and heated at 550° C. for 6 hours under nitrogen flow with the heating rate of 5° C. min⁻¹. The heating temperature is above the tellurium's melting point (450° C.) in order to completely infiltrate Te into the pores of the carbon host. Afterward, the slurry, composed of 70 wt % Te/C composite, 20 wt % super P, and 10 wt % binder (poly(vinylidene fluoride) (PVDF) in NMP or sodium alginate (SA) in water), was fully grounded and cast on an aluminum foil. After being heated at 80° C. overnight, the dried slurry was cut into pallets with 12 mm diameter as cathodes for Li—Te batteries. The S/C and Se/C composites were prepared by heating the mixture of S or Se and C at the mass ratio of 1:1 in an autoclave at 160 and 250° C. The S or Se content in S/C and Se/C composites is 50 wt %.

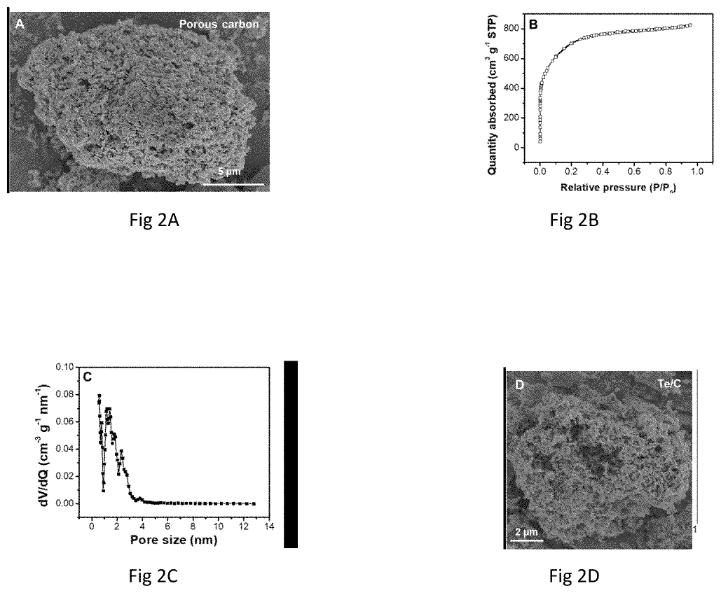

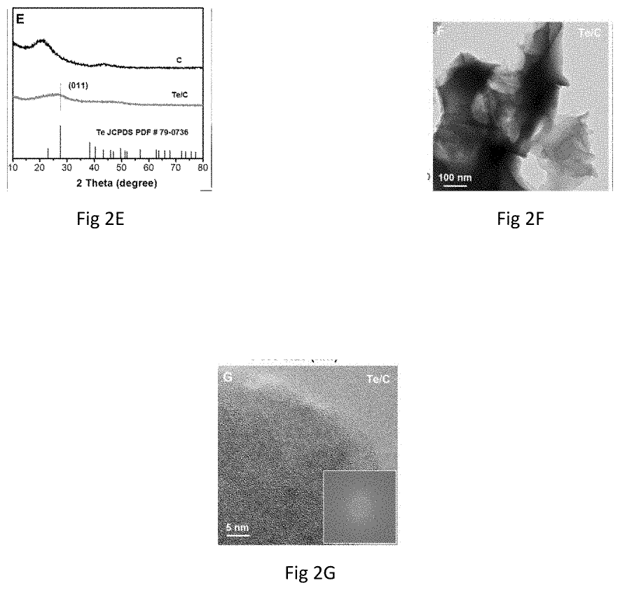

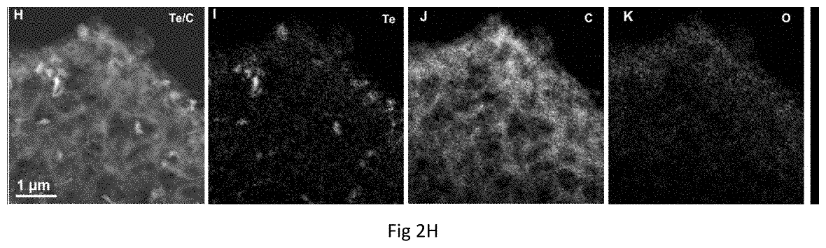

FIG. 2 shows the morphology and structure of the porous carbon and Te/C composite. The porous carbon has numerous interconnected pores (FIG. 2a) and exhibits typical type-I isotherm from the N₂ adsorption-desorption curve (FIG. 2b), revealing its microporous feature. Brunauer-Emmett-Teller (BET) analysis discloses that the porous carbon possesses a large specific area of 2345.3 m² g⁻¹ and a high pore volume of 1.15 cm³ g⁻¹, and most of the carbon pores are below 2 nm, as displayed in the pore size distribution in FIG. 2c. The unique pore structure helps complete Te infusion into carbon to synthesize Te/C composite by a melt-diffusion method and enables fast electron transfer and electrolyte penetration to facilitates the redox kinetics.

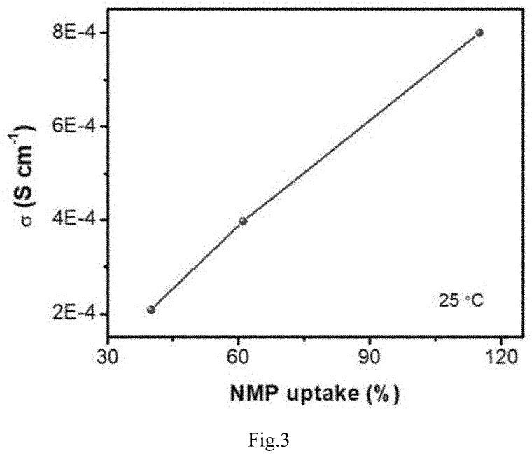

FIG. 2d displays the SEM image of the Te/C composite prepared by the melt diffusion method. After Te impregnation, Te/C composite shows no noticeable morphological change. X-ray diffraction (XRD) result reveals that the Te/C composite only has a broad diffraction peak at 27.6°, corresponding to the (011) plane of hexagonal Te (JCPDS PDF #79-0736). The disappearance of sharp diffraction peaks for crystalline Te is because Te molecules are entirely trapped in the porous carbon framework in the form of amorphous phase. This conclusion is further confirmed by Fast Fourier Transform (FFT) of high-resolution transmission electron microscopy (HRTEM) image in FIG. 2g. Transmission electron microscopy (TEM) and HRTEM images in FIGS. 2f and 3g show the uniform mixture of Te and porous carbon. Energy-dispersive X-ray spectroscopy (EDS) elemental mapping (FIG. 2g) under scanning transmission electron microscopy (STEM) shows the uniform distribution of Te in the carbon skeleton. The existence of 0 element might come from the porous carbon and traceable amount of TeO2 on Te surface. In the present example, the Te content in Te/C composite was determined to be about 50 wt % although it will be appreciated that other ratios may also be utilized including but not limited to between 40 and 90 wt %.

In the present example, the gel polymer electrolyte (GPE) is made by heating a solution of N-methyl-2-pyrrolidone (NMP), poly(vinylidenefluoride-co-hexafluoropropylene) (PVDF-HFP), and bis(trifluoromethanesulfonyl)imide lithium (LiTFSI) at 60° C. in a vacuum oven. It will be appreciated that other lithium containing salts may also be utilized including but not limited to LiClO₄, LiBF₄, LiPF₆, LiAsF₆, LiCF₃SO₃ and LiN(CF₃SO₂)₂. In particular, the synthesis steps of the gel polymer electrolyte (GPE) were conducted by a solution casting method. Firstly, poly(vinylidenefluoride-co-hexafluoropropylene) (PVDF-HFP) was dissolved into N-methyl-2-pyrrolidone (NMP) at a mass ratio of 1:4. The mixture was heated at 50° C. with continuous stirring for 12 h until a transparent and homogeneous solution was obtained. Subsequently, the bis(trifluoromethanesulfonyl)imide lithium salt (LiTFSI) was added (mass ratio of PVDF-HFP: LiTFSI=5:4) and stirred for another 12 h. Then the solution was poured onto glass containers, which was transferred to an oven and heated at 60° C. under vacuum for different time to control NMP uptake in the GPE membrane. Finally, the GPE membranes were peeled off and cut into 16 mm for cell assembly. As the NMP solvent gradually evaporates, the solution transforms into GPE with certain NMP remaining.

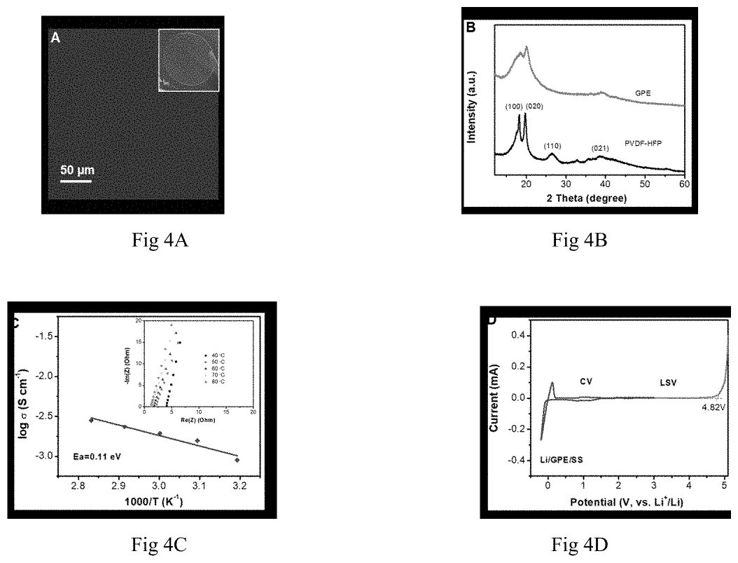

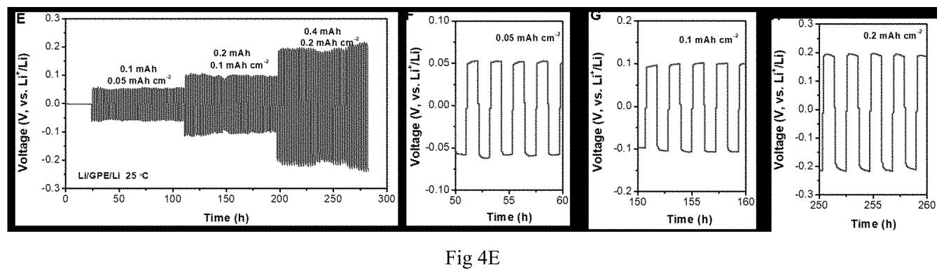

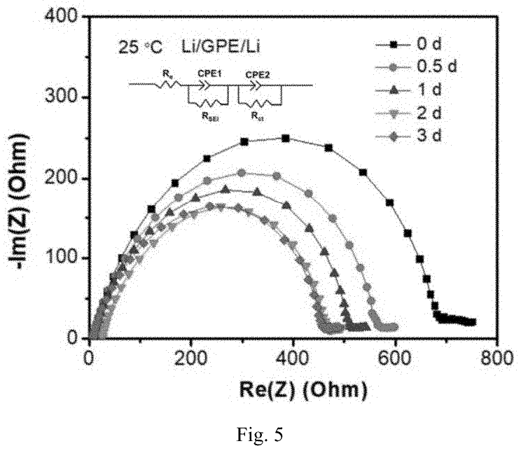

The ionic conductivity of GPE shows a strong dependence on the NMP uptake and reaches up to 8.0×10⁻⁴ S cm⁻¹ at 25° C. with an NMP uptake of 115% as illustrated in FIG. 3. FIG. 4c illustrates the Arrhenius plot of GPE in a temperature range of 40-80° C. The impedance of GPE decreases with elevated temperature due to the enhanced ion migration at high temperatures. The activation energy (Ea) of GPE is calculated to be 0.11 eV. Cyclic voltammetry (CV) curve of LiIGPEISS cells exhibits one pair of peaks at −0.20/0.11 V, assignable to Li-ion plating and stripping on stainless steel (SS), respectively (FIG. 4d). Linear sweep voltammetry (LSV) analysis shows that GPE maintains a low current until 4.82 V, indicating excellent electrochemical stability. The wide electrochemical stability window makes this GPE a good candidate for lithium batteries. Moreover, the interfacial compatibility of GPE with Li metal was assessed in Li/GPE/Li symmetrical cells, and the Nyquist plots measured at varying storage times are compared in FIG. 5. The electrolyte resistance (Re) and interfacial resistance (RSEI) of GPE remain stable at 8 and 28 Ω, respectively, even after three-day storage as illustrated on the below table:

TABLE 1
Charge Transfer resistance of the Li/GPE/Li
cell with varying storage time

| Storage | | | |
|---|---|---|---|
| time (d) | Rₑ (Ω) | R_{SEI} (Ω) | R_{ct} (Ω) |
| 0 | 9.5 | — | 684.1 |
| 0.5 | 8.1 | 30.3 | 539.6 |
| 1 | 10.0 | 28.6 | 485.0 |
| 2 | 26.2 | 26.8 | 424.6 |
| 3 | 7.4 | 28.0 | 434.6 |

This suggests its excellent interfacial compatibility between GPE and Li metal. The Li/GPE/Li symmetrical cell is also tested at various current densities of 0.05, 0.1, and 0.2 mAh cm⁻² at 25° C., and the voltage profiles are shown in FIG. 4e. The Li/GPE/Li cell exhibits flat voltage-time profiles and low overpotentials of 0.05, 0.1, and 0.2 V, at current density of 0.05 to 0.1 and 0.2 mAh cm⁻², respectively. This good interfacial compatibility probably benefits from the excellent flexibility of PVDF-HFP, efficient Li-ion conduction in GPE and interface, and tight interfacial contact. The above result shows that the flexible GPE possesses fast Li-ion transportation property, low interfacial resistance, and good electrochemical stability against Li metal.

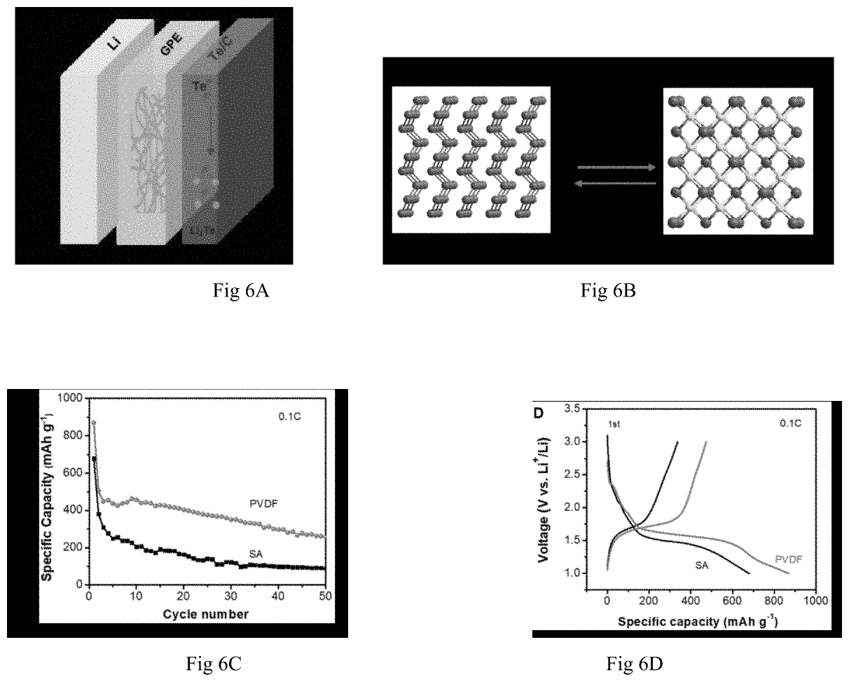

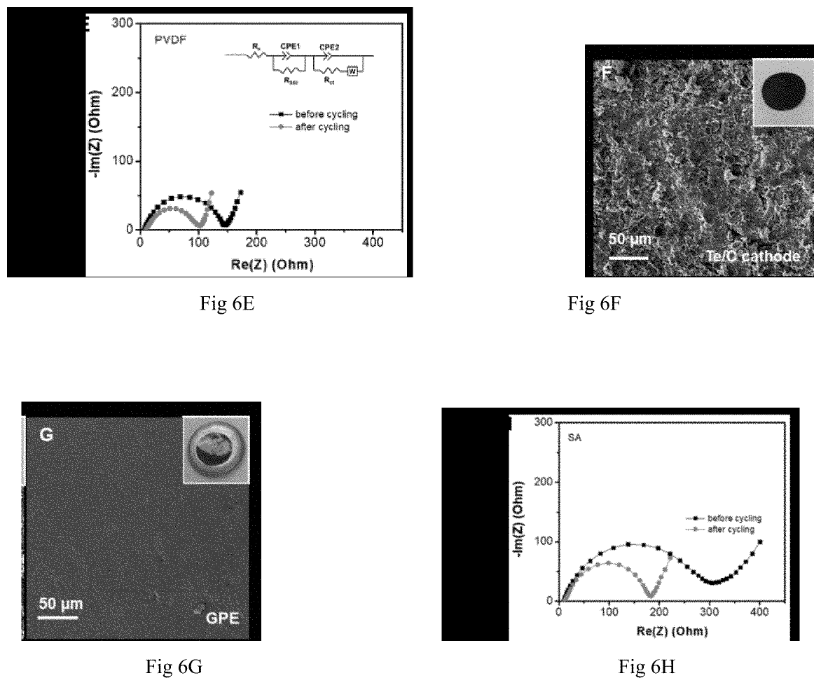

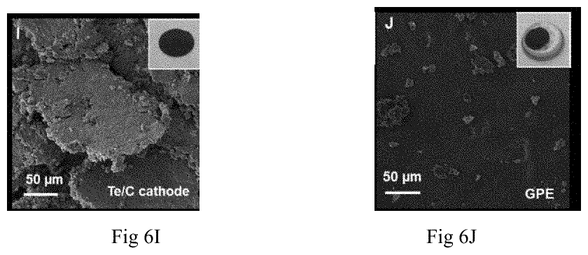

Quasi-solid-state Li—Te batteries were assembled using the optimized GPE membrane (σ=8.0×10⁻⁴ S cm⁻¹), Te/C cathode, and Li metal anode as illustrated in FIG. 6a. During the lithiation process, Te reacts with Li-ions to form cubic Li2Te, which is converted back to Te during the charge process as illustrated in FIG. 6b. This work finds that the binders (SA and PVDF) for preparing Te/C cathodes are critical for obtaining stable performance in Li—Te batteries. FIG. 6c presents the cycling stability of quasi-solid-state Li—Te batteries with SA and PVDF binders. As seen, Li/GPE/Te cell with PVDF binder delivers a high initial discharge capacity of 870.3 mAh g⁻¹, and the capacity remains stable at 420 mAh g⁻¹ for the subsequent 20 cycles. Afterward, the capacity shows a slight decrease to 256.3 mAh g⁻¹ in the 50th cycle. In contrast, the Li/GPE/Te cell with SA binder experiences a drastic decline from 679.3 mAh g⁻¹ in the first cycle to 89.2 mAh g⁻¹ in the 50th cycle. From the galvanostatic charge-discharge curves as illustrated in FIG. 6d, the Li/GPE/Te cell with PVDF shows smaller polarization than that with SA binder in the 1st, 2nd, and 5th cycle. The single charge/discharge plateaus in FIG. 6d confirm the one-step redox conversion from Te to Li₂Te in the quasi-solid-state Li—Te batteries. These results indicate that the quasi-solid-state Li—Te batteries with PVDF possess a higher electrochemical activity and better cycling stability.

EIS measurement of Li—Te batteries before and after cycling is carried out to understand binders' effect on the interfacial resistance. The initial Rct of Li—Te batteries with PVDF binder is 131.7 Ω, lower than that of SA binder (284.6 0) as illustrated in FIGS. 6e and 6h and on table 2 below.

TABLE 2
Reistances of the Li/GPE/Te cells with PVDF and SA binders

| | PVDF | | | SA | | |
|---|---|---|---|---|---|---|
| | Re | R_{SEI} | Rct | Re | R_{SEI} | Rct |
| Binder | (Ω) | (Ω) | (Ω) | (Ω) | (Ω) | (Ω) |
| Before cycling | 7.0 | — | 131.7 | 9.4 | — | 284.6 |
| After cycling | 2.0 | 8.1 | 91.8 | 10.9 | 4.5 | 158.3 |

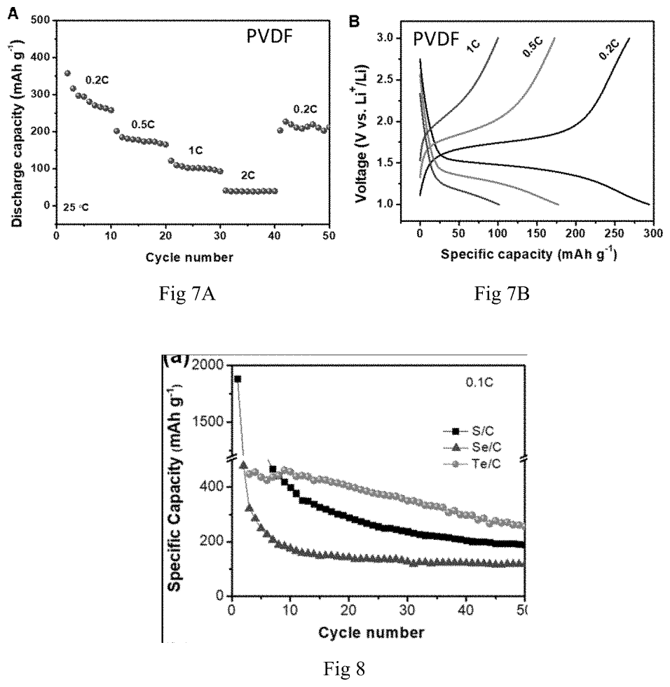

After cycling, the PVDF binder-based Li—Te battery shows decreased Rct of 91.8 Ω, still lower than that of SA binder-based one (158.3 Ω). Moreover, post-cycling observation shows that Te/C cathode with PVDF has a relatively flat and compact surface after repeated charge/discharge cycles (FIG. 6f). The GPE surface is dense and smooth (FIG. 6g), implying good structural stability of battery components with PVDF binder. However, for the SA-based cells, many Te/C electrode materials are stuck onto GPE and peeled off from the current collector, leading to severe pulverization and delamination (FIG. 6i). The active materials are also found on the GPE surface (FIG. 6j), and the yellowish GPE membrane is indicative of partial dehydrofluorination of PVDF-HFP chains. The difference in electrochemical performance and structural stability of PVDF and SA-based cells could be due to the following reasons. i) PVDF has better compatibility with GPE components (PVDF-HFP polymer and NMP solvent) and higher electronic conductivity than SA, contributing to the lower interfacial resistance. ii) PVDF has higher adhesive strength with the current collector than SA to prevent active materials from delamination, thus maintaining superior structural stability after long cycling. Herein, the PVDF binder is more suitable for the quasi-solid-state Li—Te battery to achieve excellent capacity and stability. The PVDF binder-based Li—Te battery also demonstrates good rate capacities of 357.4, 184.8, 109.1, and 38.5 mAh g⁻¹ at 0.2, 0.5, 1, and 2 C, respectively as illustrated in FIG. 7. It should be noteworthy that SA was reported to enable better cycling stability than PVDF does in liquid Li—S or Li—Se batteries. The opposite observation in our work is probably due to different lithium-ion migration pathways in the liquid and solid electrolytes. The rich carboxyl and hydroxyl groups in SA are beneficial for absorbing sufficient solvent molecules from liquid electrolytes to enhance lithium-ion diffusion. However, the lithium-ion transportation in the GPE mainly relies on the segmental movement of PVDF-HFP polymer chains and the interaction with limited NMP. Therefore, PVDF with better compatibility with GPE contributes to superior capacity and electrochemical/structural stability in quasi-solid-state Li—Te batteries.

FIG. 8 illustrates the cycling performance of Te. S/C and Se/C quasi-solid-state Li-chalcogen cells at 0.1 C (based on the mass of active materials, i.e., 167.5 mA g⁻¹ for S, 67.5 mA g⁻¹ for Se 42 mA g⁻¹ for Te). Although S/C and Se/C cathodes deliver high initial capacities of 1882.6 and 1105.7 mAh g⁻¹, their capacities rapidly drop to 188.6 and 117.3 mAh g⁻¹ after 50 cycles. In comparison, Te/C sustains a relatively stable capacity and remains 256.3 mAh g-1 in the 50th cycle.

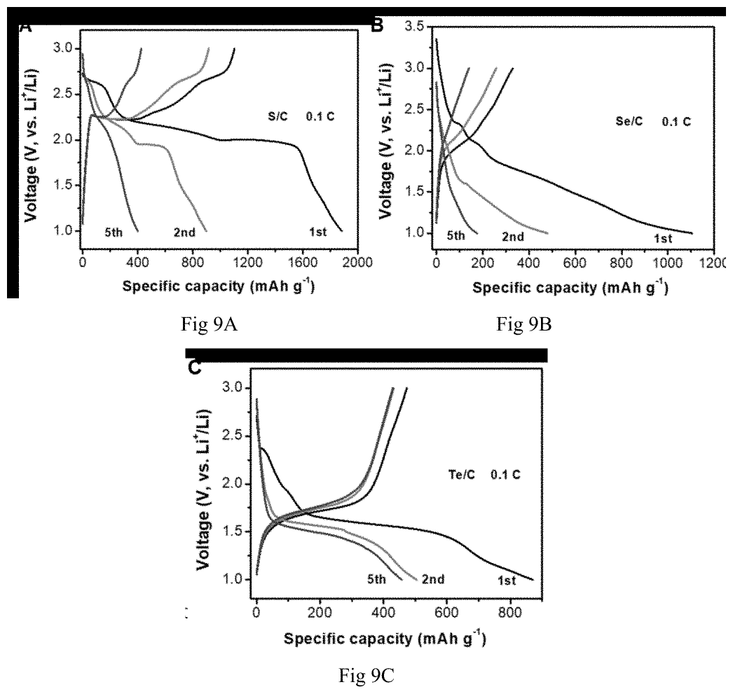

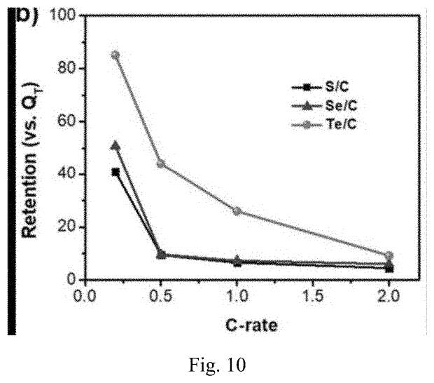

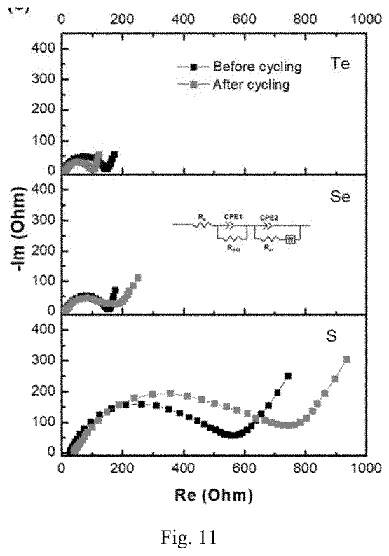

FIG. 9 depicts the galvanostatic charge-discharge profiles of all the Li—S/Se/Te batteries. It is found that the lithiation/de-lithiation plateaus become narrower versus cycle number, implying poor reversibility of S/C and Se/C cathodes in GPE-based batteries. In contrast, Te/C cathode exhibits well-overlapped voltage profiles. FIG. 10 shows capacity retention (vs. corresponding theoretical capacity) of Li—S/Se/Te batteries at 0.2-2 C. The Te/C cathode retains 85.1%, 44.0%, and 26.0% outperforming S/C (41.0%, 9.5%, and 6.7%) and Se/C (50.8%, 9.6%, and 7.3) cathodes, at 0.2, 0.5, and 1 C, respectively. From the EIS spectra in FIG. 11, the Te/C cathode has the smallest Rct (131.7 Ω) compared to S/C (518.8 Ω) and Se/C (136.0 Ω) cathode before cycling (, verifying the fastest electron transfer in the Te/C cathode. After repeated redox reactions, S/C and Se/C cathodes have enlarged Rct of 562.8 and 131.2 Ω and RSEI of 98.8 and 49.0 Ω, whereas Te/C cathode presents the smallest Rct of 91.8 Ω and RSEI of 8.1 Ω. Therefore, fast electron transfer and low interfacial resistance in the Te/C cathode result in enhanced reaction kinetics, making Te stand out as a promising cathode material in the GPE-based quasi-solid-state batteries. It should be noted that this comparison aims to verify the applicability of the GPE in lithium-chalcogen batteries using the same cathode structure and preparation procedures and the electrochemical performance of S/Se cathodes could be improved through the optimization of cathode structure.

While specific embodiments have been described and illustrated, such embodiments should be considered illustrative only and not as limiting the disclosure as construed in accordance with the accompanying claims.

What is claimed is:

1. A lithium ion battery comprising:
a lithium anode,
a tellurium cathode; and
a gel polymer electrolyte.

2. The lithium ion battery of claim 1 wherein the gel polymer electrolyte comprises a polymer matrix and a lithium compatible salt.

3. The lithium ion battery of claim 2 wherein the polymer matrix comprises poly(vinylidene fluoride-co-hexafluoropropylene).

4. The lithium ion battery of claim 2 wherein the lithium compatible salt comprises and bis(trifluoromethanesulfonyl)imide lithium.

5. The lithium ion battery of claim 1 wherein the tellurium cathode comprises a quantity of tellurium encapsulated in porous carbon.

6. An electrolyte for use in a lithium ion battery comprising a gel polymer matrix and a lithium compatible salt.

7. The electrolyte of claim 6 wherein the gel polymer matrix comprises poly(vinylidene fluoride-co-hexafluoropropylene).

8. The electrolyte of claim 6 wherein the lithium compatible salt comprises bis(trifluoromethanesulfonyl)imide lithium.
